(19) United States
(12) Patent Application Publication
(10) Pub. No.: US 2004/0100448 A1
(43) Pub. Date: May 27, 2004

(54) Touch display

(75) Inventor: Robert S. Moshrefzadeh, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/303,377

(22) Filed: Nov. 25, 2002

(51) Int. Cl. G09G 5/00

(52) U.S. Cl. 345/173

(57) ABSTRACT

A thin display of a touch user interface is disclosed. The display includes a thin, emissive touch element such as an electroluminescent display panel. Force sensors are disposed in such a way to determine a location of a touch on an emissive display.

### FIELD OF THE INVENTION

This invention relates to touch displays. In particular, the invention relates to electroluminescent displays having force-based touch input detection.

### BACKGROUND OF THE INVENTION

Electronic displays are widely used in all aspects of life. Although in the past the use of electronic displays has been primarily limited to computing applications such as desktop computers and notebook computers, as processing power has become more readily available, such capability has been integrated into a wide variety of applications. For example, it is now common to see electronic displays in a wide variety of applications such as teller machines, gaming machines, automotive navigation systems, restaurant management systems, grocery store checkout lines, gas pumps, information kiosks, and hand-held data organizers to name a few.

In response to the more ubiquitous use of electronic displays, it has been increasingly desired that displays be made compact in size, especially thin. In particular, significant progress has been made in making displays that are relatively large in viewing area with a relatively small border and a thin design. The most common thin display type used today is the liquid crystal display (LCD). For larger display types, for example, displays having a diagonal of greater than 40 inches, plasma displays are commonly used.

As electronic displays are more widely used there is a greater desire to improve the user input functionality, leading to an increased use of touch sensor user inputs. Touch sensors typically involve some sort of capacitive or resistive type sensor placed in front of the electronic display to determine the location of a touch on the touch sensor, which correlates to a position on the display. The occurrence and location of the touch are then provided to the processor controlling the information presented on the display, which typically performs specified functions in response to the touch and modifies the information displayed on the electronic display.

As electronic displays coupled with touch sensors are used in a wide variety of applications, it has become increasingly desirable to have a display incorporating touch functionality, a touch display, which can be used in the various new applications as well as providing improved performance in existing applications.

Thus, there remains a need to find an improved touch display, which is adaptable to a variety of applications, is relatively thin and compact in design, and provides improved performance over existing touch displays.

### SUMMARY OF THE INVENTION

Generally, the present invention relates to touch displays and methods of displaying information and receiving touch input. In accordance with one embodiment, a touch display includes an electroluminescent (EL) display and two or more sensors that are used to sense the location of a force applied to a touch surface. In one embodiment the forces applied to the touch surface pass through the touch surface to the sensors and information from the sensors is used to determine the location of a touch.

In a particular embodiment, the touch surface is the emitting surface of the EL display itself. In an alternative embodiment, the touch surface may include a transparent touch element that is disposed proximate to the emitting surface of the EL display.

In various embodiments, the force sensors may be disposed on the emitting surface side of the display or on a side of the EL display opposite to the touch surface. In one embodiment, the force sensors are disposed between an emitting surface of the EL display and a transparent touch element.

In various embodiments where a transparent touch element is used, additional functionality may be incorporated into the transparent touch element. For example, the transparent touch element may include a contrast enhancement layer such as a circular polarizer or color filter.

In accordance with one embodiment of the invention, the touch input display is used in environments where inertial forces are applied to the display. In one embodiment, an inertial sensor is disposed within the touch display, and information gathered by the inertial sensor is used in conjunction with the force sensors to determine the occurrence or location of a touch.

The above summary of the present invention is not intended to describe each disclosed embodiment or every implementation of the present invention. The Figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 illustrates a touch display in accordance with one embodiment of the invention;

FIG. 2 illustrates a touch display in accordance with another embodiment of the invention;

FIG. 3 illustrates an embodiment of a force sensor in accordance with one particular embodiment of the invention;

FIG. 4 illustrates a diagram of various components of a touch display in accordance with an embodiment of the invention;

FIG. 5 illustrates a fixed touch display application in accordance with an embodiment of the invention; and

FIG. 6 illustrates a touch display in a mobile display application.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE ILLUSTRATED EMBODIMENTS

The present invention is directed generally to touch displays that include an electroluminescent (EL) display and two or more force sensors that are used to determine a location of a force applied to a touch surface based on the forces passed through the touch surface to the sensors. It is generally desirable to have relatively thin and compact displays for a number of applications. Moreover, it is also desirable to have touch input capability in such displays. Many touch displays that are incorporated onto thin displays incorporate a conventional capacitive or resistive touch sensor onto an LCD. There are a number of problems associated with such displays. First, it is typically required that the touch sensor be physically separated from the display. This is because the liquid crystal displays are not well adapted to be touched. For example, the polarizer necessary for display function may be damaged. Moreover, when touching a LCD there is a noticeable effect, often referred to as bruising, that occurs as the liquid crystal material is compressed and displaced. This effect is not only distracting, but highlights the sensitivity of such displays to repeated touches. Rigidizing LCDs to make them less susceptible to bruising involves using much thicker glass as the front LCD substrate or using a rigid overlay spaced apart from the front of the LCD. Either case can result in a thicker, heavier display, and may additionally result in losses to resolution, contrast, and transmission.

Another problem with a conventional LCD/touch sensor arrangement is the durability of such displays. It is difficult to make LCDs that have high temperature durability and performance in a wide variety of end use applications. Additionally, it is difficult to construct touch sensors that are also adaptable to such environments. For example, a conventional resistive touch sensor typically has a glass surface coated with a transparent conductive material such as ITO and a polymer surface also coated with a transparent conductive material spaced apart from the glass surface. Such sensors are not well adapted for use in high temperature environments.

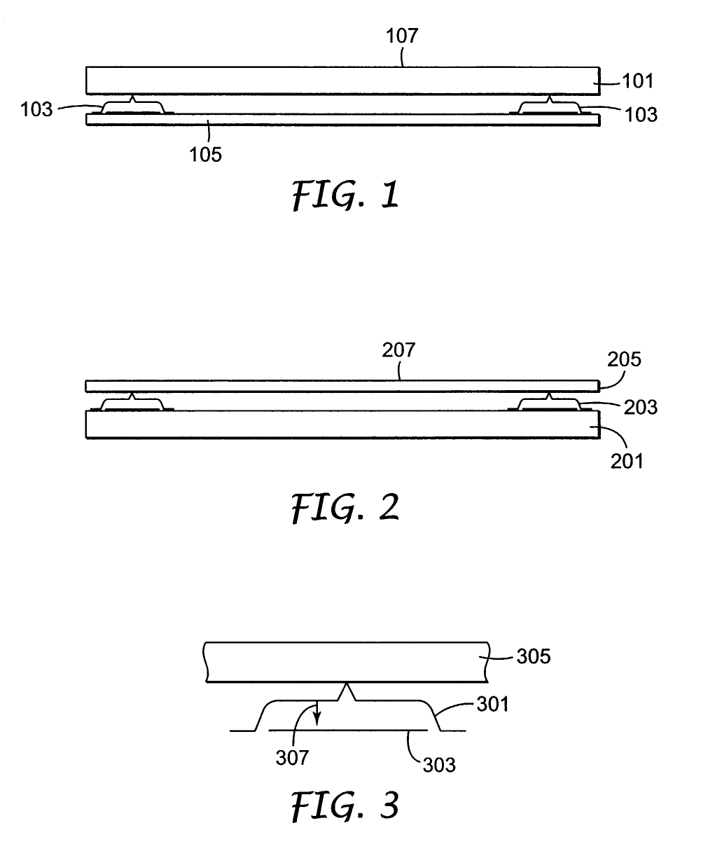

In accordance with one embodiment of the present invention, the above drawbacks of conventional touch displays are overcome. As illustrated in FIG. 1, an EL display 101 is used as the display element. The EL display does not have the above-described drawbacks associated with LCDs. In particular, EL displays have good temperature durability and by virtue of their construction, are not susceptible to damage by repeated touches.

The EL display 101 is supported by two or more force sensors 103. The force sensors 103 are mounted on a support base 105. When a point on the top surface 107 is touched, a force will be imparted through the EL display to the force sensors 103. By measuring the relative magnitudes of the forces at the location of the sensors, a position of the touch can be determined. One advantage of such an arrangement is that the location of the touch can be determined independent of the instrument used to touch the surface 107. For example, a stylus may be used, a finger may be used, or a finger wearing a glove. In each instance, the force sensors 103 will register a touch on the surface 107 of the EL display 101 in a similar manner.

The electroluminescent display 101 can be any of a variety of known electroluminescent displays. For example, the display may be an organic electroluminescent display (OLED), an inorganic electroluminescent display, or a display based on the combination of the two. The EL display 101 may be a segmented display, a pixilated display, a high information content or low information content display, and the like. The display may further be a multi-colored display, full-colored display, or a monochromatic display as desired in the particular application.

The force sensors, as well as the housing and other elements (not shown) are preferably the force sensors described in International Publications WO 2002/084580, WO 2002/084579, WO 2002/084578, and WO 2002/084244, all of which are incorporated herein by reference.

The surface 107 of the EL display 101 may further have additional functionality. For example, structures may be incorporated into the surface 107 that serve to extract light more efficiently from the EL display 101. Such structures are described in co-pending International Publications WO 2002/37568 and WO 2002/37580, the contents of which are incorporated herein by reference. These structures may also serve to impart a textured surface to the surface 107 of the EL display 101 to provide a more tactilely accurate surface for writing or otherwise using a writing implement on the surface of the display.

The surface 107 of the EL display 101 may further have contrast enhancement functionality integrated thereon. For example, a circular polarizer may be laminated or otherwise attached to the emitting surface side of the of the EL display. The circular polarizer will function to provide contrast enhancement when the display is used in conditions where a significant amount of ambient light is present. Such contrast enhancement is particularly desirable due to the high reflectivity of the typical electrode used in EL display 101. As an alternative, color filters may be used for contrast enhancement. Color filters are particularly well suited for monochrome or segmented color displays. In such a system, a filter designed to absorb all wavelengths of light other than that emitted by the particular display (or segment) is disposed over the display. The above described contrast enhancement color filters are known to those of skill in the art.

The surface 107 of the EL display 101 may also be treated to have anti-reflective properties. For example, various coatings of different materials having different refractive indices may be used to decrease the amount of reflection. Alternatively, or in addition to the anti-reflection, the surface may be provided with an anti-glare surface. The anti-glare surface may be achieved by etching the surface 107 of the EL display, or by laminating or otherwise adhering a textured surface onto the surface 107. Alternatively, an anti-glare coat may be sprayed directly onto the surface of the EL display 101.

The surface 107 of the EL display 101 may also be treated with other functional layers. For example, a low surface energy material may be applied to the surface in order to increase cleanability of the display. A hardcoat may be applied to the surface 107 to improve durability of the display in response to multiple touches. An anti-microbial treatment may also be applied to the surface of the EL display as described in co-pending International Publication WO00/20917, the contents of which are incorporated herein by reference. Also, thin polymer films may be laminated to or otherwise disposed on surface 107, for example to provide resistance to damage.

Another embodiment of a touch display in accordance with the present invention is illustrated in FIG. 2. In FIG. 2, an EL display 201 of a variety of types such as those described above, is provided. Force sensors 203 are provided on a surface of the EL display 201 on the side where light is emitted from the EL display 201. A touch surface 205 is supported by the force sensors 203 and spaced a distance apart from the emitting surface of the EL display 201. When a force is applied to the top surface 207 of the touch surface 205, the touch surface 205 is displaced in a direction towards the EL display 201. In this manner, the force applied to the top surface 207 of the touch surface 205 is passed to the force sensors 203. Based on the relative amounts of force passed to the force sensors 203, a location of the touch on the touch surface 207 is determined.

As described above in connection with the top surface 107 of the EL display 101 in connection with FIG. 1, the touch surface 205 may include additional functionality such as any or all of the above described functionality.

Because the touch surface 205 is separate from the EL display 201, the touch surface 205 can be easily manufactured to have a variety of different properties. Moreover, the touch surface element may be any of glass, polymers, acrylics, and the like.

The force sensor that may be used in connection with one particular embodiment of the present invention is illustrated in FIG. 3. As noted above, two such force sensors can be used to determine the touch location in one direction. The distance of a touch from the sensors can be determined using the magnitude of the force sensed by the sensors. Three or more touch sensors can be used to determine the location of a touch in both the x and y direction of the plane of the touch surface. It is generally preferable to have four or more touch sensors as described in the above-referenced International Publications WO 2002/084580, WO 2002/084579, WO 2002/084578, and WO 2002/084244. The force sensor depicted in FIG. 3 includes two conductive elements. The first conductive element 301 is formed of a metal material having a generally spring like behavior. The metal material forms a peak, which contacts the bottom surface of an element sitting on the force sensor 305. As described previously in connection with FIGS. 1 and 2, the bottom surface may be either the bottom surface of a separate touch element or of the EL display itself.

A second conductive element 303 is provided beneath the first conductive element 301. As a force is applied to element 305, the first conductive element 301 is displaced in a downward direction as indicated by arrow 307. In this manner, the first conductive element 301 is brought closer to the second conductive element 303. In this configuration, the conductive elements 301 and 303 are arranged to function as a capacitor. As the top portion of the first conductive element 301 is displaced towards the second conductive element 303, a change in capacitance is determined. This change in capacitance can be used to determine the amount of force applied to the particular sensor. As described above, when multiple sensors are used, one can then determine the relative forces applied to each of the sensors, and hence, the location of a touch.

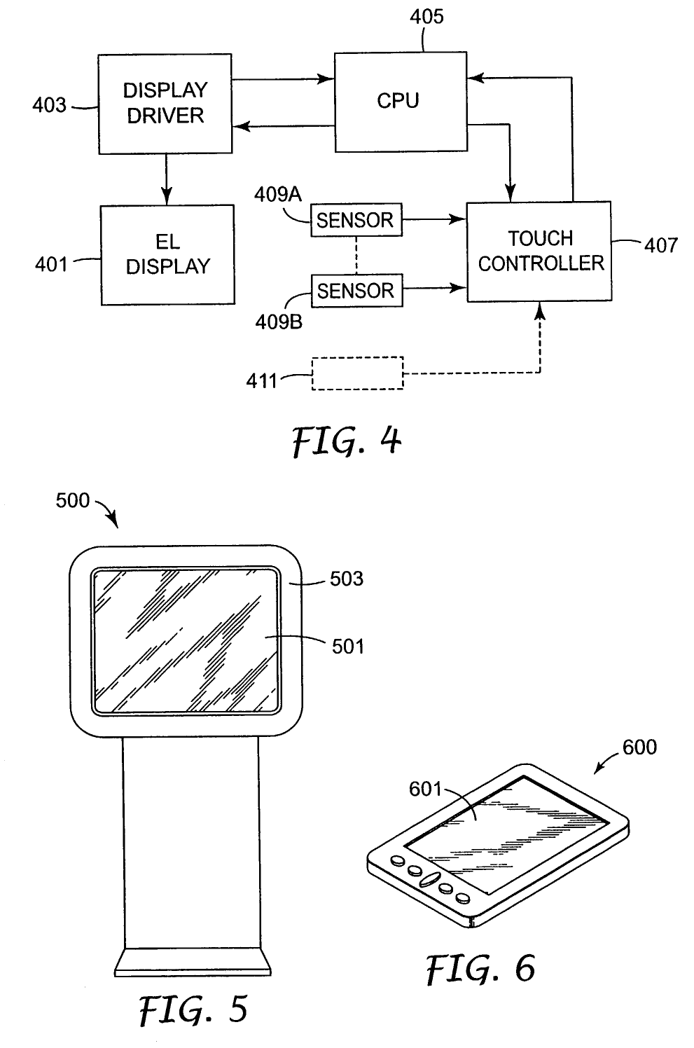

FIG. 4 illustrates in block diagram form the various components of a touch-enabled display in accordance with the present invention. An EL display 401 is coupled to a display driver 403. The display driver 403 is coupled to a processing unit 405, which controls the information to be displayed on the EL display 401. The processor 405 may be a general-purpose computer or a special purpose computer, depending upon the application for which the touch display is to be used. The touch controller 407 is coupled to the central processing unit 405 and to the force sensors 409a and 409b. While only two force sensors are shown, it should be understood that as many force sensors as are needed to accomplish the touch sensing operation can be used. Furthermore, while the processor 405 and touch controller 407 are illustrated separately, it will also be recognized that a single processor unit could accomplish the functions of these two elements. In operation, the sensors 409 sense the magnitude of the applied force. The output of the sensors may be a relative change in capacitance between the various sensors, for example, when the sensors illustrated in FIG. 3 are used. The touch controller then processes this information to determine the location of a touch. This information is provided by the touch controller 407 to the CPU 405, which uses the information in accordance with an application program running on the processor 405. Typically in response to a touch, some element displayed on the EL display 401 is changed as the processing unit 405 controls the display driver 403 to alter the information displayed on the EL display 401. In this manner, a touch display using an EL display 401 and a force-based sensor can be used.

From the above description it will be appreciated that in accordance with the present invention the combination of a highly durable relatively thin display element with force sensors that are also durable and can be made thin, provides a touch display with significant advantages over that previously known. Such displays may be used in fixed applications as illustrated in FIG. 5. The kiosk 500 includes a touch display 501 disclosed within a housing 503. Force sensors (not shown) may be disposed between the surface of an EL display and a touch element over the display as described in the exemplary embodiment of FIG. 2, or maybe disposed behind the EL display within the housing 503 as described in connection with FIG. 1. It will be appreciated that where the force sensors are disposed behind the EL display, the optics of the display is optimally presented since there are no intervening surfaces between the display and the viewer.

FIG. 6 illustrates a hand-held embodiment of a touch display in accordance with the present invention. A hand-held or portable device incorporates a touch display in accordance with the present invention. The touch display includes an EL display element 601 and force-based sensors used to determine the location of a touch on the display. When the touch display in accordance with the present invention is used in mobile devices, the impact of inertial forces of the display must be taken into account because such forces may impact the force sensors used to determine the pressure of and the location of a touch. Such inertial forces are particularly present in hand-held devices and devices that are installed in moving vehicles such as automobile navigation systems. Returning to FIG. 4, an optional inertial force sensor (e.g., accelerometer) can be incorporated into the touch display. This inertial force sensor senses the amount, magnitude and various attributes of inertial forces sensed by the touch display. Where these forces are determined not to contribute to an accurate location of the touch, they can be removed by the touch controller as described in commonly assigned in U.S. patent application Ser. No. 09/882,338, U.S. Pat. No. 6,285,385, the contents of which are incorporated herein by reference.

The advantages of the present invention will be appreciated from the above description. The invention should not be considered limited to the preferred embodiments. Alternative embodiments may be readily apparent to the skilled artisan upon review of the present specification. For example, other functionality may be incorporated into the touch surface. A variety of end use applications of the described touch display will also become apparent.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A touch display comprising:
an electroluminescent (EL) display viewable through a touch surface; and
a plurality of sensors disposed to sense a location of a force applied to the touch surface based on forces passed through the touch surface to the sensors.

2. A touch display as recited in claim 1, wherein the touch surface comprises an emitting surface of the EL display.

3. A touch display as recited in claim 2, wherein the force sensors are disposed on a side of the EL display opposite the touch surface.

4. A touch display as recited in claim 1, wherein the touch surface comprises a transparent touch element disposed on an emitting surface of the EL display.

5. A touch display as recited in claim 4, wherein the plurality of force sensors are disposed between the emitting surface of the EL display and the transparent touch element.

6. A touch display as recited in either of claims 4 or 5, wherein the transparent touch element comprises a contrast enhancement layer.

7. A touch display as recited in claim 6, wherein the contrast enhancement layer comprises a circular polarizer.

8. A touch display as recited in claim 6, wherein the contrast enhancement layer comprises a color filter.

9. A touch display as recited in claim 1, further comprising an inertial sensor disposed to sense inertial forces applied to the display.

10. A touch input display comprising:
an electroluminescent (EL) display element having a touch surface;
a plurality of sensors configured to output signals representative of forces applied to the sensors, the sensors being arranged to receive a force representative of a force applied to the touch surface;
a processor coupled to the force sensors to determine a location of a touch on the touch surface based on the output signals and for altering information displayed on the EL display element in response to the touch.

11. A touch input display as recited in claim 10, wherein the touch surface comprises an emitting surface of the EL display element.

12. A touch input display as recited in claim 10, wherein the touch surface comprises transparent overlay disposed on an emitting surface of the EL display element.

13. A touch input display as recited in claim 12, where in the force sensors are disposed between the emitting surface of the EL display element and the transparent overlay.

14. A touch input display as recited in claim 13, wherein the force sensors comprise two conductive elements spaced apart to form a capacitor and the output signals of the force sensors represents relative movement of the two conductive elements.
